(19) United States
(12) Patent Application Publication
(10) Pub. No.: US 2015/0074659 A1
(43) Pub. Date: Mar. 12, 2015

(54) Methods and Apparatus to Perform Web-Based Installations and/or Upgrade Architectures for Enterprise Software

(71) Applicant: VMware, Inc., Palo Alto, CA (US)

(72) Inventors: Anders Bach Madsen, Skoedstrup (DK); Rene W. Schmidt, Risskov (DK); Steffen Grarup, Hoejbjerg (DK)

(73) Assignee: VMware, Inc., Palo Alto, CA (US)

(21) Appl. No.: 14/230,999

(22) Filed: Mar. 31, 2014

Related U.S. Application Data
(60) Provisional application No. 61/874,899, filed on Sep. 6, 2013.

(51) Int. Cl. G06F 9/445

(52) U.S. Cl. CPC G06F 8/61
USPC 717/177

(57) ABSTRACT

Methods, apparatus, systems and articles of manufacture are disclosed to perform web-based installations and/or upgrade architectures for enterprise software. An example method disclosed herein includes obtaining configuration information at an installation handler via a web-based interface, the configuration information including a source locator identifying a source location of a source package and a target locator identifying a target machine on which to install the source package, the target machine being separate from the installation handler and the source location. The example method also includes validating the configuration information, and, in response to determining that the configuration information is valid, deploying the source package to the target machine.

### RELATED APPLICATION

This patent claims the benefit of U.S. Provisional Application Ser. No. 61/874,899, filed on Sep. 6, 2013, which is hereby incorporated herein by reference in its entirety.

### FIELD OF THE DISCLOSURE

This disclosure relates generally to virtualized computing environments, and, more particularly, to methods and apparatus to perform web-based installations and/or upgrade architectures for enterprise software.

### BACKGROUND

Installation of a product traditionally involves running an installer program provided on a DVD or downloaded from the web. When a product includes several applications, such as an enterprise software suite, each application may need a separate installer program. As a result, installing such a product can be a complex and laborious process.

### BRIEF DESCRIPTION OF THE DRAWINGS

FIG. 1 is a diagram of an example environment constructed in accordance with the teachings of this disclosure to perform web-based installations and upgrade architectures for enterprise software.

FIG. 2 illustrates an example system constructed in accordance with the teachings disclosed herein to implement web-based installations and upgrade architectures of enterprise software.

FIG. 3 illustrates an example implementation of the virtual machine template of FIG. 2.

FIG. 4 illustrates an example implementation of the installation handler of FIGS. 1 and/or 2.

FIG. 5 illustrates an example OVF Tool service command that may be executed by the example installation handler of FIGS. 1, 2 and/or 4 to deploy the example virtual machine package of FIGS. 1 and/or 2 and to obtain feedback to drive a user interface.

FIG. 6 is an example sequence diagram that may be used to implement web-based installation of an enterprise software suite.

FIG. 7 is an example sequence diagram that may be used to implement a web-based installation of enterprise software across multiple deployed virtual machines using virtual machine templates.

FIGS. 8-10 are flow charts representative of example machine-readable instructions that may be executed to perform web-based installations and upgrade architectures for enterprise software.

FIG. 11 is a block diagram of an example processing platform capable of executing the example machine readable instructions of FIGS. 8-10 to implement the example installation handler of FIGS. 1, 2 and/or 4.

### DETAILED DESCRIPTION

Installing a computer product such as a computer program traditionally involves running an installer program provided on a storage disk (e.g., a DVD) or downloaded from the Internet. When a product includes several computer programs that each need a separate installer program, the installation process can be complex and may involve a large installation guide. Example methods and apparatus disclosed herein provide a web-based installation handler that enables a user (e.g., an information technology (IT) administrator, a system administrator, an entity, a business, an organization, etc.) to install a full enterprise software suite directly from a web page (e.g., hosted at a package hosting server) onto a host machine (e.g., a computing server utilizing a hypervisor or a virtualization platform, etc.) while decreasing the amount of needed user involvement relative to prior installation techniques. Examples disclosed herein also enable using the disclosed architecture of the web-based installation handler to support parallel deployment to multiple hosts, to support patch upgrading, and to support guest operating system deployments (e.g., mixed Windows® operating system deployments).

A virtual machine is a pre-configured software stack comprising one or more operating systems, applications and/or services. Each virtual machine is an independently installable run-time entity comprising an operating system, application(s) and other application specific data, as well as specifications of the virtual hardware required by the virtual machine to execute on a host machine. Examples disclosed herein transport the virtual machine from the package hosting server to the host machine via a virtual machine package. A virtual machine package (sometimes referred to herein as a “package,” a “virtual appliance” or a “virtual machine image”) includes all the services and applications included in the virtual machine as well as any additional information, drivers, agents, etc. needed to make the virtual machine executable by the user upon installation. The virtual machine package also includes deployment information (e.g., execution flow, metadata, scripts, etc.) to deploy the software in the package according to a prescribed (e.g., predetermined) pattern. The deployment information may include instructions to determine, for example, whether specific services or applications can be installed on the host machine, thereby preventing incompatible and/or unneeded software from being installed on the host machine. Thus, examples disclosed herein simplify the installation and operational procedures as well as improve performance and robustness.

Examples disclosed herein include a package portal that is accessible by a web browser to initiate installation. For example, a user may navigate to a web page using a web browser on a management client, provide user credentials, verify licenses, and select a virtual machine to install. The example package portal prompts the user for information regarding the specific installation (e.g., a target host machine locator, login credentials for the target host machine, etc.) and installs (e.g., automatically, near automatically, limited user input, etc.) a web-based installation handler onto the user's client with information used by the installation handler to deploy the virtual machine to the target host machine. For example, the package portal may identify the location of a source file (e.g., a virtual machine package corresponding to the selected virtual machine) to deploy and set the hostname and the provided login credentials of the target host machine as provided by the user. In some examples, the installation handler, once loaded onto the management client, verifies the information (e.g., checks security certificates, etc.) and initiates a deployment tool to deploy the identified virtual machine package to the target host machine. The example deployment tool enables streaming the virtual machine package to the target host machine without downloading (e.g., storing) the virtual machine package at the management client. Thus, the management client acts as a relay (e.g., proxy) during the virtual machine package deployment process.

In some examples, the installation handler monitors the streaming process and passes the progress to the browser, thereby enabling the user to view the streaming progress. In some examples, the installation handler powers on the deployed virtual machine and sets the specified customization options on the target host machine. In some such examples, the installation handler may wait for the deployed virtual machine to boot and provide live (e.g., real-time or near real-time) updates of the installation process to the user via the browser.

In some examples, the virtual machine package is deployed from a remote machine. For example, the management client may access the package portal via a public network such as the Internet. Although a public network is used in the illustrated example, private network(s) and/or virtual private network(s) (VPN) may additionally or alternatively be employed. In some examples, the virtual machine package is deployed from local storage. For example, the management client may access the package portal via a private or datacenter network such as an Intranet. In some such examples, the package portal, the installation handler and the virtual machine package may be stored locally in the virtual computing environment. In some examples, the package portal is integrated with a virtualization platform installer program. In some such examples, when installing a virtualization platform (sometimes referred to herein as a “virtualization layer,” a “hypervisor” or a “virtual machine monitor”) onto a computing server in the virtual computing environment, the package portal may also load and prompt the user to select one or more virtual machines to install.

Examples disclosed herein may be scaled-out to enable parallel streaming of virtual machine packages to facilitate multiple virtual machine deployments such as an enterprise software suite (sometimes referred to as a “software suite” or a “distributed software system”). Typically, an enterprise software suite includes a relatively large collection of loosely-coupled services or virtual machines. For example, an enterprise software suite may include database servers, application servers, presentation servers, API (application program interface) proxy servers, single sign-on servers, licensing servers, etc. As a result, installing an enterprise software suite on one or more host machines in a virtual computing environment may include loading multiple DVDs or downloading respective installer programs for the different software included in the software suite.

To facilitate parallel streaming of virtual machine packages, examples disclosed herein utilize virtual machine templates in the virtual machine packages. In examples disclosed herein, a virtual machine template groups together one or more virtual machines, services and/or applications that are repeatedly deployed. Thus, each virtual machine template can provide a subset of the software of the enterprise software suite. In some examples, a virtual machine template is created from the one or more virtual machines included in the virtual machine template. Virtual machine templates (sometimes referred to herein as “templates”) are typically developed, tested, deployed and patched as a whole (e.g., virtual machine image), and, thereby, provide a standardized group of hardware and/or software settings that can be used and reused to create new virtual machines configured with those settings. For example, the virtual machine templates may include and/or identify virtual hardware, guest operating system and/or software applications to enable the virtual machine to execute on a virtualized platform. Virtual machine templates, thus, improve on the process of extending the single virtual machine deployment to a multi-virtual machine (e.g., an enterprise software suite) deployment by, for example, enabling “cookie cutter” deployment of software of the enterprise software suite and, thereby, increasing performance, availability and extensibility of the enterprise software suite installation.

Table 1 below illustrates seven example virtual machine templates that may be used to deploy an enterprise software suite. Each row illustrates an example virtual machine template and the corresponding service(s) included in the template.

TABLE 1

| Virtual Machine Template | Content |
|---|---|
| VMT0 | Relational Database Services |
| VMT1 | Site Manager, Component Manager |
| VMT2 | Core Services |
| VMT3 | User Interface Services |
| VMT4 | Virtualization Manager |
| VMT5 | Virtual Datacenter Provisioning Services |
| VMT6 | Security Services |

In some examples, the virtual machine templates of Table 1 are assigned to services based on 1) whether a service is a data service (e.g., a database server) or a computational service (e.g., an application server, a presentation server, etc.), 2) the update cadence of the service, and/or 3) whether the service is a required service or an optional service in the enterprise software suite. For example, the update cadence (e.g., the frequency with which updates occur) for computational services is generally shorter than for data services because computational services include the software to implement the features of the suite. As virtual machine templates are updated and/or patched as a whole, it would become inefficient and impractical to have to replace large data services each time a computational service is updated. Thus, in some examples, computational services and data services are not included in the same virtual machine template. Further, including required services and optional services (e.g., virtual machines developed by a third-party) in a same virtual machine template may lead to superfluous upgrades of required services when optional services are updated and/or may result in an unnecessarily complicated uninstallation process of optional services based on upgrades to required services. Thus, in some examples, required services and optional services are separated and not included in the same virtual machine template. However, other principles for assigning the services to virtual machine templates are also possible.

Table 2 below illustrates an example mapping of service identifiers for various services to corresponding virtual machine templates as may be used in an example installation of an enterprise software suite using the virtual machine templates identified in Table 1.

TABLE 2

| Service Identifier | Virtual Machine Template |
|---|---|
| SiteDB | VMT0 |
| SiteManager | VMT1 |
| vCenterDB | VMT0 |
| Core Services | VMT2 |
| Software Suite UI | VMT3 |
| vCenter Server | VMT4 |
| vCD Cell | VMT5 |
| vShield | VMT6 |

In the example illustrated by Table 2 above, a zeroth virtual machine template (VMT0) represents a relational database services template and is deployed twice in the standard installation of the enterprise software suite to create two instances identified as SiteDB and vCenterDB. As a result, rather than developing, testing and deploying the SiteDB service and the vCenterDB service separately for installation in the enterprise software suite, the same relational database services template (e.g., the virtual machine template (VMT0)) may be deployed twice and then configured accordingly.

As described above, a virtual machine package includes deployment information (sometimes referred to herein as an “execution flow” or an “installation pattern”) to deploy the package software in a desired pattern. Thus, in some examples in which a virtual machine package deployed to a host machine includes one or more virtual machine templates, the virtual machine package includes an execution flow for, for example, a site-wide installation of the enterprise software suite. For example, an enterprise software suite execution flow may include one or more site-wide services (e.g., Base services), one or more services that can work independently from other services (e.g., Zone services), and respective count values indicating how many of each virtual machine template can be deployed for the installation. Table 3 below illustrates an example installation pattern for the enterprise software suite.

TABLE 3

| Group | Element | Virtual Machine Template | Count |
|---|---|---|---|
| Site | Base | n/a | 1 |
| | Zone | n/a | 1+ |
| Base | SiteDB | VMT0 | 0 or 1 |
| | SiteManager | VMT1 | 1 |
| Zone | vCenterDB | VMT0 | 0 or 1 |
| | Core Services | VMT2 | 1 |
| | Software Suite UI | VMT3 | 0 or 1 |
| | vCenter Server | VMT4 | 1 |
| | vCD Cell | VMT5 | 1+ |
| | vShield | VMT6 | 1 |

In the example illustrated in Table 3 above, the installation pattern indicates that a site-wide installation includes one base services component and one or more zone services components. For example, a site-wide installation may include zero or one base SiteDB template and will be provided with one base SiteManager template. Further, a site-wide installation of the enterprise software suite of the illustrated example may include zero or one zone vCenterDB template, zero or one zone Software Suite UI template, one zone Core Services template, one vCenter Server template and one vShield template, and at least one vCD Cell template. In some examples, the number of each respective virtual machine template depends on the configuration of the virtual computing environment. For example, if the virtual computing environment includes an external database, then the SiteDB service and/or the zone vCenterDB service may not be configured, and a reference to the external database may be used in the component manager.

Examples disclosed herein enable performing web-based installations of one or more virtual machines, services and/or applications onto one or more host machines by deploying virtual machine package(s) to the host machines via an installation handler. As used herein, a virtual machine package may include one or more virtual machine templates. As used herein, a virtual machine template may include one or more guest operating systems, one or more applications and/or one or more services. Thus, in some examples, a virtual machine package may include a template for one virtual machine, while another virtual machine package may include templates for multiple virtual machines of an enterprise software suite. Some examples disclosed herein may include providing deployment information so that the enterprise software suite software may be installed on host machines using different patterns and, thereby, ensuring that the enterprise software suite may be installed to support different scale and availability goals of different customers.

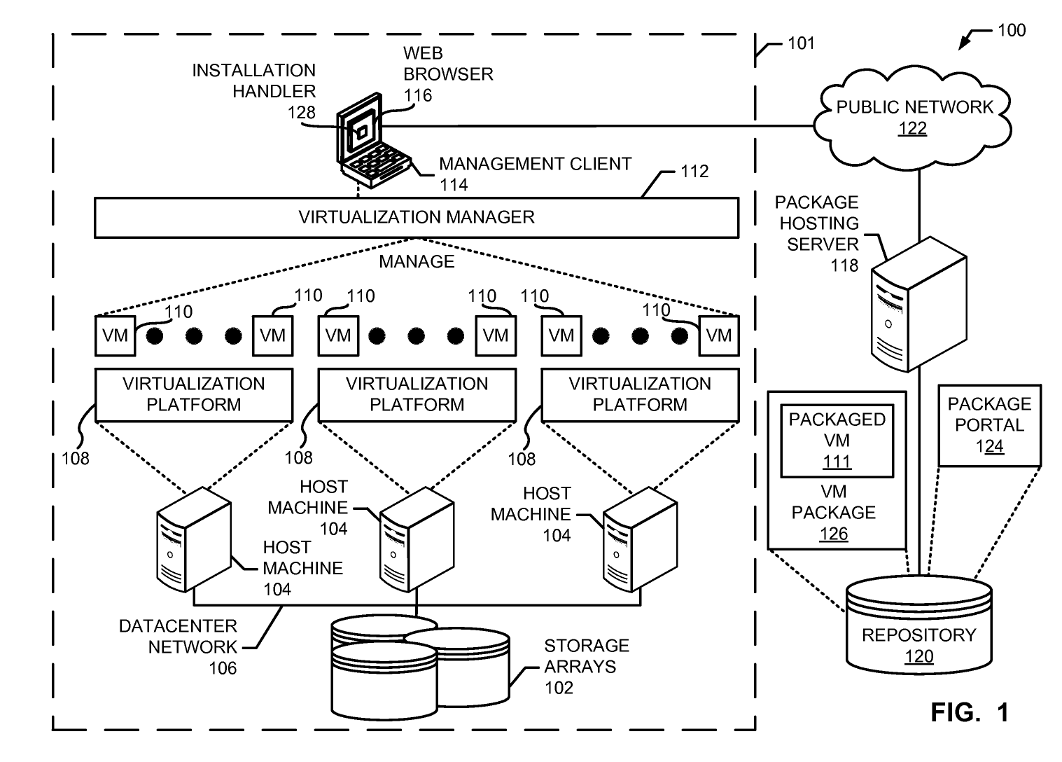

FIG. 1 is an illustration of an example computing environment 100 including an example virtual computing environment 101 constructed in accordance with the teaching of this disclosure. The example virtual computing environment 101 of FIG. 1 includes an example network of storage arrays 102 in communication with example host machines 104. The example network of storage arrays 102 may be implemented using any suitable wired and/or wireless storage including, for example, one or more Fiber Channel Storage Area Network (SAN) arrays, one or more Internet Small Computer System Interface (iSCSI) SAN arrays, one or more Network Attached Storage (NAS) arrays, etc. In the illustrated example, the network of storage arrays 102 are connected to and shared between groups of servers through storage area networks, thereby enabling aggregating storage resources and enabling increased flexibility in provisioning the storage resources to, for example, example virtual machines 110.

In the illustrated example of FIG. 1, the example host machines 104 may be x86 computing servers in communication with the example network of storage arrays 102 via an example datacenter network 106. The example datacenter network 106 of FIG. 1 may be implemented using any suitable wired and/or wireless network(s) such as, for example, one or more data buses, one or more Local Area Networks (LANs), one or more wireless LANs, an Intranet, etc.

In the illustrated example of FIG. 1, the example host machines 104 provide example virtualization platforms 108. The example virtualization platforms 108 of FIG. 1 respectively execute on corresponding ones of the example computing servers 104. An example virtualization platform 108 (sometimes referred to as a “virtualization layer,” a “hypervisor” or a “virtual machine monitor”) abstracts processors, memory, storage and/or other resources of the host machines 104 into one or more virtual machines 110. In the illustrated examples, a virtual machine 110 includes an operating system and/or executes one or more applications and/or services. In some examples, the virtualization platform 108 may be installed on a host machine 104 that does not have an operating system. In some such examples, the virtualization platform 108 is referred to as a bare metal hypervisor. In some examples, the virtualization platform 108 may be installed on a storage device rather than on a computing server. The example virtualization platform 108 virtualizes and aggregates the underlying physical hardware resources (e.g., some or all of the example network of storage arrays 102 and/or the example host machines 104) across the physical computing environment and provides pools of virtual resources available for use in the virtual computing environment 101. Thus, by using the resources available from the physical components of the virtual computing environment 101, the example virtual machines 110 may request resources dynamically as a workload increases, and/or may release resources dynamically as the workload decreases.

The example virtual machines 110 of FIG. 1 may be designated to a particular host, cluster or resource pool, or a datacenter when they are created. A host is a physical computing server executing a virtualization platform 108. When two or more physical computing servers are grouped to work and be managed as a whole (e.g., as a single entity or computing resource), the aggregate computing and memory resources may be referred to as a cluster. In some examples, a computing server may be dynamically added or removed from a cluster. Computing and memory resources from hosts and/or clusters may be partitioned into a hierarchy of resource pools.

To manage the virtual computing environment 101, the example virtual computing environment 101 of FIG. 1 includes an example virtualization manager 112. The example virtualization manager 112 provides a single point of control (or point of access) to the virtual computing environment 101. In the illustrated example, the virtualization manager 112 manages the assignments of virtual machines 110 to be virtualized on corresponding ones of the host machines 104, and manages the assignments of resources of the host machines 104 to the virtual machines 110. In the illustrated example, the virtual computing environment 101 is accessible via an example management client 114. For example, a virtual machine 110 in the virtual computing environment 101 may be accessed via a web access interface such as an example web browser 116 of the client 114. In some examples, the virtualization manager 112 may include one or more interfaces that enable other applications to manage the example virtual computing environment 101 and access the example virtualization platforms 108 and/or the example virtual machines 110. In addition, for simplicity, only one management client 114 is shown in FIG. 1, although multiple clients may be present.

In the illustrated example of FIG. 1, the example environment 100 includes an example package hosting server 118 in communication with an example repository 120. In the illustrated example of FIG. 1, the repository 120 is a database that hosts virtual machine packages that may be retrieved by the package hosting server 118. In some examples, the package hosting server 118 is implemented using multiple devices and/or the repository 120 is implemented using multiple devices. For example, the package hosting server 118 and/or the repository 120 may include disk arrays or multiple workstations (e.g., desktop computers, workstation servers, laptops, etc.) in communication with one another. In the illustrated example, the package hosting server 118 is in selective communication with the management client 114 and/or the repository 120 via one or more wired and/or wireless networks represented by a public network 122 (e.g., the Internet). The example public network 122 of FIG. 1 may be implemented using any suitable wired and/or wireless network(s) such as, for example, one or more data buses, one or more Local Area Networks (LANs), one or more wireless LANs, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather includes selective communication at periodic or aperiodic intervals, as well as one-time events.

In the illustrated example of FIG. 1, a package development entity such as VMware, Inc. operates and/or hosts the example package hosting server 118. The package hosting server 118 of the illustrated example is a server that responds to requests for installing and/or upgrading one or more virtual machine(s) (e.g., an enterprise software suite). For example, a user may access an example package portal 124 via the web browser 116 of the client 114. In some such examples, the package portal 124 may enable a user to select one or more virtual machines 110 to install or upgrade onto a host machine 104. For example, the package portal 124 may be provided with a graphical user interface for enabling a user to interact with the package portal 124 and to select virtual machines 110 to install or upgrade. In the illustrated example of FIG. 1, the package portal 124 is a static, HTML webpage designed using cascading style sheets (CSS). However, the package portal 124 may be developed using other styles such as HTML5, JavaScript and/or CSS. In some examples, the package portal 124 and the package hosting server 118 are integrated. In some examples, the package portal 124 is retrieved by the package hosting server 118 from, for example, the repository 120.

In the illustrated example of FIG. 1, in response to the package portal 124 receiving a request to install virtual machine 110 onto a host machine 104, the package portal 124 installs an example installation handler 128 on the management client 114. In the illustrated example, the installation handler 128 is a browser plug-in. For example, the installation handler 128 may be a web-based plug-in for the web browser 116. In some examples, the installation handler 128 facilitates installing and/or upgrading a virtual machine on a host machine by providing interoperability between the package portal 124 and the web browser 116. For example, the installation handler 128 may provide an interface (e.g., a JavaScript application program interface (API)) for the package portal 124 to initiate a deployment tool to stream a virtual machine package to a host machine.

In some examples, in response to a selection by the user, the package hosting server 118 retrieves an example virtual machine package 126 including an example packaged virtual machine 111 corresponding to the selected virtual machine(s) from the repository 120. The package hosting server 118 then serves the retrieved virtual machine package 126 to the management client 114 via the public network 122. For example, the user may initiate deploying the virtual machine package 126 from the package hosting server 118 to one or more host machines 104 by pressing an “Install” button displayed by the web browser 116, entering a hostname and login credentials of the one or more host machines 104 on which to load the virtual machine package 126, and selecting deployment option(s) such as the name of the administrator account, whether to enable secure shell (SSH) by default on each of the host machines 104, etc.

Installation begins and the management client 114 streams the example virtual machine package 126 including the example packaged virtual machine 111 directly from the package hosting server 118 to the target host machine 104. In the illustrated example of FIG. 1, the virtual machine 110 in the virtual computing environment 101 and the virtual machine 111 represent the same virtual machine at two different points in time. The virtual machine 110 in the virtual computing environment 101 is a run-time format virtual machine installed on a virtualization platform 108 and ready for execution. The virtual machine 111 in the virtual machine package 126 is a virtual machine prior to installation on a virtual platform 108. For example, the packaged virtual machine 111 in the virtual machine package 126 may be a compressed virtual machine, an image (e.g., a virtual machine image) of a virtual machine, etc. and will be installed onto a host machine prior to execution. Thus, when a user selects to install or upgrade the virtual machine 110 onto a host machine 104, the example package portal 124 determines a virtual machine package including a pre-installation copy of the virtual machine 110 (e.g., the example virtual machine package 126 including the example packaged virtual machine 111) and deploys the virtual machine package 126 to the target host machine 104. The example installation handler 128 of the illustrated example enables the package portal 124 to stream the virtual machine package 126 to the host machine 104. The installation handler 128 also initiates installing the virtual machine 110 onto the host machine 104 by causing the virtualization platform 108 to boot the packaged virtual machine 111 in the virtual machine package 126.

As described above, in some examples, the management client 114 acts as a proxy. In some examples, the virtual machine package 126 is deployed from the package hosting server 118 to the host machines 104 via the management client 114 without the management client 114 first storing the virtual machine package 126. In some examples, the installation handler 128 enables displaying the status of the installation progress to the user via the web browser 116. For example, the installation handler 128 may send a message to the virtualization platform 108 for download progress or initiation progress updates. The example installation handler 128 may present the progress to the user via the web browser 116. In some examples, when the virtual machine package 126 is deployed, a web page or a link to a web page specific to the selected virtual machine(s) corresponding to the deployed virtual machine package 126 is displayed to the user, thereby enabling the user to configure the packaged virtual machine 111 for the specific deployment environment. For example, additional configuration of the software included in the virtual machine package 126 can be done through a management interface included in the virtual machine package 126 itself, such as a server or a web interface.

In the illustrated example of FIG. 1, the package hosting server 118 and the repository 120 are external to the virtual computing environment 101. In some such examples, the management client 112 provides a point of access for the package hosting server 118 to the host machines 104. That is, the example package hosting server 118 and the repository 120 are in communication with the virtual computing environment 101 via the management client 114 rather than, for example, directly with one or more of the host machines 104 in the virtual computing environment 101.

In some examples, the package hosting server 118 and the repository 120 are internal to the virtual computing environment 101. For example, an enterprise may have policies that prevent connections to the Internet and/or some internal services may have slow connections to outside services. Thus, by incorporating the package hosting server 118 and the repository 120 in the virtual computing environment 101, the example package hosting server 118, the example package portal 124 and the example installation handler 128 enable offline installation of virtual machine(s) without requiring the management client 114 to communicate via the public network 122.

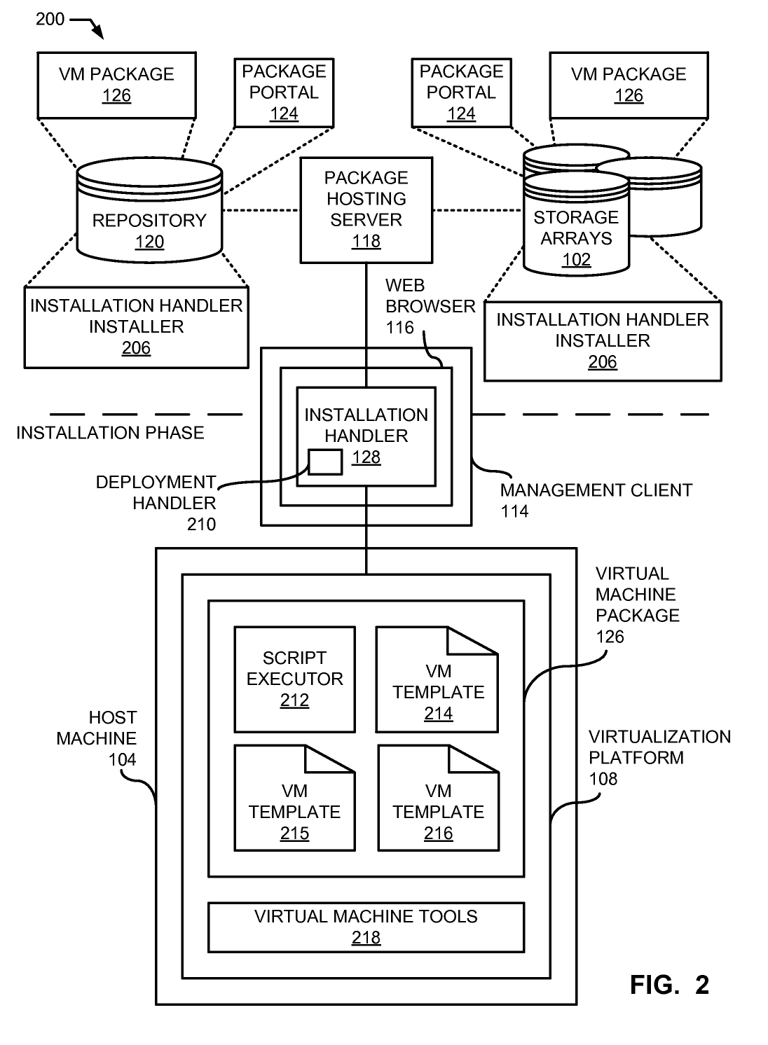

FIG. 2 illustrates an example system 200 to perform online and/or offline, web-based installation of virtual machines based on an enterprise software suite. In the illustrated example of FIG. 2, the example system 200 includes the example management client 114 in communication with the example package hosting server 118 and the example host machine 104 executing the example virtualization platform 108 (FIG. 1).

In some examples, the package hosting server 118 is in communication with the management client 114 via the example network 122 (FIG. 1). In some such examples, an online installation of the virtual machine(s) corresponding to the virtual machine package 126 may be performed when the package hosting server 118 retrieves the example package portal 124 and/or the example virtual machine package 126 from the example repository 120. For example, when a user selects a virtual machine to install via the package portal 124, the package portal 124 may include metadata indicating that the virtual machine package 126 is stored at an online storage location.

In some examples, the package hosting server 118 is in communication with the management client 114 via the example datacenter network 106 (FIG. 1). In some such examples, the package hosting server 118 retrieves the example package portal 124 and/or the virtual machine package 126 from the example network of storage arrays 102. For example, the package hosting server 118, the package portal 124 and the virtual machine package 126 may be stored in the network of storage arrays 102 and accessed by the management client 114 at a later time to perform an offline installation. In the illustrated example of FIG. 2, metadata included in the package portal 124 is modified to indicate that the installation is an offline installation and that the virtual machine package 126 is located on local storage (e.g., the network of storage arrays 102) rather than at an online storage location.

In some examples, the package hosting server 118 is included in a hypervisor installer program used to install a hypervisor onto a computing server. For example, the package hosting server 118 may load onto the computing server during the installation process of the virtualization platform 108. In some such examples, the installation may be an online installation or an offline installation depending on whether the package portal 124 and the virtual machine package 126 are retrieved from an online storage location (e.g., the repository 120) or from local storage (e.g., the network of storage arrays 102). In some examples, it may be beneficial to utilize an online installation in order to limit the size of the hypervisor installer program rather than increase the size of the hypervisor installer program by including the virtual machine package 126 in the hypervisor installer program. Further, in some such examples, the package portal 124 may directly initiate a deployment tool included in the hypervisor installer program and/or the virtualization platform 108 and, as a result, the package portal 124 may not install the installation handler 128 for the installation and/or upgrade process.

To facilitate online and/or offline installation of the selected virtual machine(s), the example package hosting server 118 of the illustrated example installs the example installation handler 128 on the management client 114. For example, the package hosting server 118 may retrieve an example installation handler installer 206 from the repository 120 during an online installation or from the network of storage arrays 102 during an offline installation and load the installation handler 128. In the illustrated example of FIG. 2, the example installation handler 128 is a web-based browser plug-in developed using a secure framework such as Firebreath. The example installation handler 128 of FIG. 2 is provided with an example deployment handler 210 to facilitate streaming the virtual machine package 126 to the host machine 104. The example deployment handler 210 may be a command-line based service, a scripted service or a graphical installation wizard. An example command-line based service is the OVF (Open Virtual Machine Format) Tool service, a product developed by VMware, Inc. The OVF Tool service enables importing and/or exporting OVF packages to and/or from many different types of sources and targets such as, for example, host machines, clusters, resource pools and/or datacenters. In some examples, the OVF Tool service is integrated into the virtualization platform. In some such examples, the installation handler 128 acts as a conduit between the deployment handler 210 and the web browser 116. For example, the installation handler 128 may provide a JavaScript application program interface (API) allowing the portal package 124 to initiate the deployment handler 210 via the web browser 116. That is, the example installation handler 128 of FIGS. 1 and 2 provides interoperability between the portal package 124 and the deployment handler 210 to, thereby, enable the portal package 124 to communicate with the deployment handler 210.

In the illustrated example of FIG. 2, the virtual machine package 126 is streamed to the computing server 104 during the deployment phase. For example, the installation handler 128 may execute the OVF Tool service via the example command-line:
ovftool [options] <source> <target>

In some such examples, the source field stores a reference identifying a particular virtual machine package to deploy, and the target field stores a reference identifying a particular target host machine on which the virtual machine package is to deploy.

In the illustrated example, the options field stores any host machine preferences specified by the user while selecting the virtual machine to install. For example, the options field may identify whether SSH should be enabled by default on the target host machine. In some examples, the customization options indicate whether the example packaged virtual machine 111 is to install using default settings. For example, a user may elect to utilize an external component such as a third-party database, a third-party installer program, etc. In some such examples, when the customization options are set, then the user may be prompted to provide the location of the external component (e.g., the location of the third-party database), manually install the component (e.g., via the third-party installer program), etc. In some examples, the third-party installer program is a different product provided by the enterprise software suite deployer. For example, the deployer may make available two different databases, and while the enterprise software suite may include a first database, the organization installing the enterprise software suite may use the second database and wish to continue using the second database in their system or try the second database after already using the first database. In some examples, the installation process may wait until the manual steps are completed by the user.

In the illustrated example, the source field, the target field and the options field are provided by the portal package 124 to the installation handler 128 during installation of the installation handler 128.

In the illustrated example of FIG. 2, the installation handler 128 validates the fields provided by the package portal 124. For example, the installation handler 128 may verify the locator (e.g., hostname) of the target host machine, may check certificates of the virtual machine package, etc. Once the installation handler 128 verifies the information, the installation handler 128 initializes the deployment handler 210 to stream the source file (e.g., the virtual machine package 126) to the target host machine 104.

In the illustrated example, the virtual machine package 126 is loaded by the example virtualization platform 108. In the illustrated example of FIG. 2, the virtual machine package 126 is provided with an example script executor 212 and example virtual machine templates 214-216. The example script executor 212 of FIG. 2 executes scripts that may be provided with the virtual machine package 126. For example, the script executor 212 may execute first boot scripts to trigger installing the software provided with the virtual machine package 126 in the virtualization platform 108. In some examples, the script executor 212 of FIG. 2 executes a script (e.g., an execution flow) to deploy the example virtual machine templates 214-216 in a pattern or order. For example, the installation handler 128 may select virtual machines to boot, and then the script executor 212 may coordinate deploying the virtual machine templates 214-216 by, for example, controlling the deployment order to ensure any dependencies are satisfied, providing setup information to the virtual machines (e.g., an IP address, the location for dependent components, etc.). In some examples, the installation handler 128 may use resource configurations to deploy virtual machine templates, what order to deploy the virtual machine templates, and provide the setup information for the virtual machines without the script executor 212 executing a script. In some examples, the installation handler 128 determines which virtual machines to boot. The example installation handler 128 may then boot the virtual machines in a pattern or order. In some such examples, the script executor 212 included in the virtual machine package 126 may then execute a script to trigger installing the software. As discussed above, a virtual machine package may be provided with one or more services, applications and/or virtual machine templates. Thus, although the example virtual machine package 126 of FIG. 2 includes the three example virtual machine templates 214-216, a virtual machine package may not include any virtual machine templates or may include any suitable number of virtual machine templates such as one, two, or four, etc.

In some examples, the installation handler 128 may utilize services of the virtualization platform 108 during the installation phase. For example, virtual machine tools 218 may provide an updated IP address of the virtualization platform 108 after a system boot. In some such examples, the installation handler 128 employs the IP address from virtual machine tools 218 to generate a link to monitor the installation progress of the virtual machine(s). For example, the installation handler 128 may poll a progress monitoring service provided with the virtual machine template 214 using the IP address provided by the virtual machine tools 218.

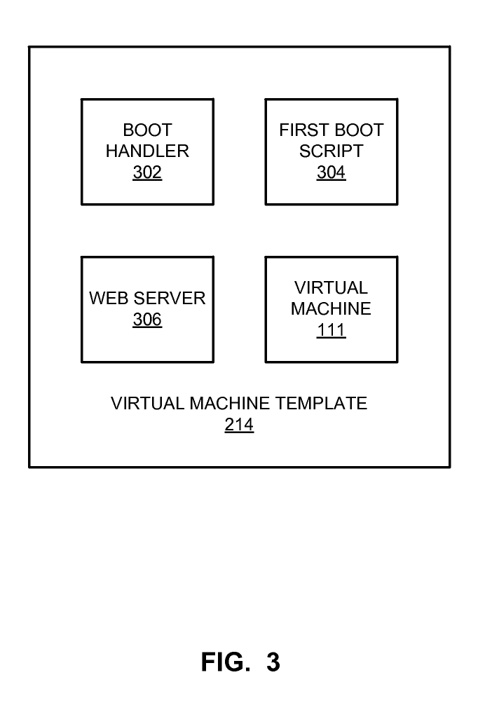

FIG. 3 illustrates an example implementation of the example virtual machine template 214 of FIG. 2. The example virtual machine template 214 may be provided with the virtual machine package 126 of FIGS. 1 and/or 2. As described above, a virtual machine template is a reusable image created from a virtual machine. The virtual machine template may include virtual hardware, installed guest operating system, and/or software applications such as drivers and/or agents to enable the virtual machine to execute on a virtualization platform. For example, a template author may assemble, test and/or certify one or more services and/or applications, and then package the one or more services and/or applications into a template for repeated, “cookie cutter” deployment. Thus, a virtual machine template may include a virtual machine executable independent of any other software or a subset of software of, for example, an enterprise software suite.

In the illustrated example of FIG. 3, the example virtual machine template 214 is provided with an example boot handler 302 to cause the host machine (e.g., the example host machine 104 of FIGS. 1 and 2) to boot an installer program upon reboot (e.g., install the software provided with the virtual machine template). In the illustrated example, the boot handler 302 of FIG. 3 executes the example first boot script 304 to customize the installation for the specific deployment environment (e.g., the example virtual computing environment 101 of FIG. 1). Example customizations for the installation may include localization of the interface language(s) of the packaged virtual machine 111, review, sign-off and/or enforcement of end user license agreements (EULA), setting resource configurations, loading drivers, agents, tools, services, etc. that, for example, are not included in the host virtualization platform.

In the illustrated example of FIG. 3, the example virtual machine template 214 is provided with an example web server 306 to monitor initialization progress of the packaged virtual machine 111. In the illustrated example, the web server 306 of FIG. 3 is a server that the installation handler may query about the boot state of the packaged virtual machine 111. For example, the web server 306 may provide JavaScript Object Notation (JSON) documents including a progress count on the initialization when polled by, for example, the installation handler 128. In some examples, the web server 306 may utilize security tokens to establish secure two-way communication with the installation handler 128. In some examples, the web server 306 is provided with a management interface (e.g., a web page interface) to enable a user to perform additional customizations of the packaged virtual machine after the first boot up of the virtual machine 111.

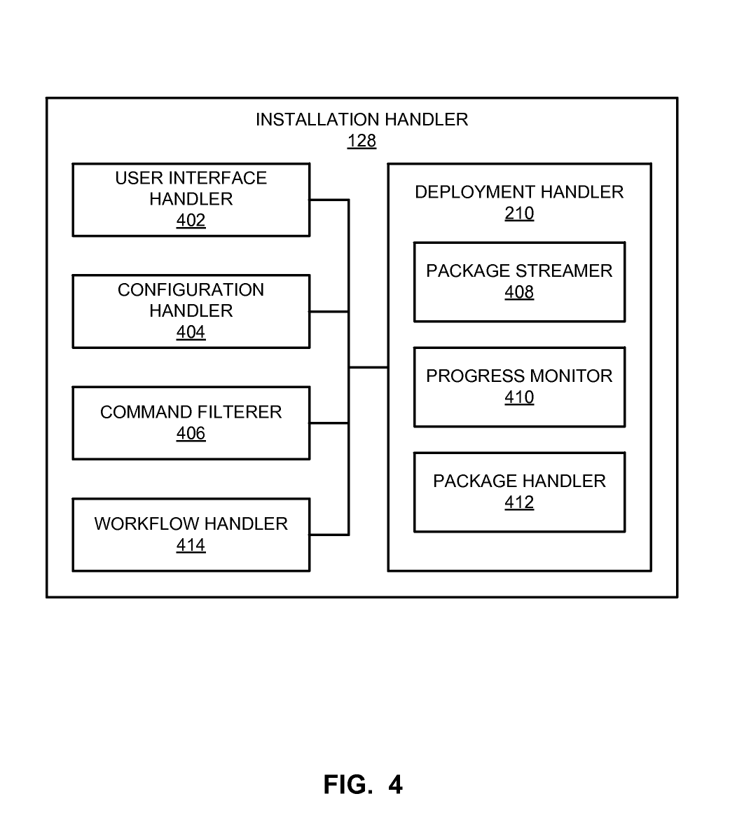

FIG. 4 illustrates an example implementation of the example installation handler 128 of FIGS. 1 and/or 2. In the illustrated example of FIG. 4, the installation handler 128 facilitates web-based installation and/or upgrade of virtual machine(s) onto host machine(s) in the virtual computing environment 101 of FIG. 1. The example installation handler 128 of FIG. 4 is provided with an example user interface handler 402, an example configuration handler 404, an example command filterer 406, an example workflow handler 414 and the example deployment handler 210.

In the illustrated example of FIG. 4, the installation handler 128 is provided with the example user interface handler 402 to handle a web interface associated with the installation process. For example, the user interface handler 402 may display virtual machine package streaming progress monitoring information and/or virtual machine initiation progress monitoring information via a web page. In some examples, the user interface handler 402 displays a web interface using the web browser 116 of FIGS. 1 and 2 after initiation is complete to enable the user to configure additional preferences and/or settings of the virtual machine 110.

In the illustrated example of FIG. 4, the installation handler 128 is provided with the example configuration handler 404 to set the deployment configuration settings for the deployment handler 210. For example, the configuration handler 404 may retrieve (1) a source location reference for the virtual machine package to deploy, (2) one or more target host machine locators to which the virtual machine package is to be deployed to, and (3) configuration options from the example package portal 124 of FIGS. 1 and/or 2. In some examples, the configuration handler 404 validates the source file, target host machine and/or configuration options information prior to initializing the deployment handler 210. For example, the configuration handler 404 may check the authenticity of the virtual machine package 126 by comparing a certificate included in the binary of the virtual machine package. In some examples, the configuration handler 404 validates the target host machine by determining whether the target host machine is available. For example, the configuration handler 404 may send a message to (e.g., a request message, a ping, etc.) the target machine locator to check the presence of the target host machine and wait for a response to the request message. If the configuration handler 404 of this example receives a response from the target host machine corresponding to the target machine locator, the configuration handler 404 determines that the target host machine is available (e.g., live, active, etc.). Otherwise, if the configuration handler 404 of this example does not receive a response from the target host machine (e.g., the request message “times-out,” receives a response from a different host machine, etc.), the configuration handler 404 determines that the target host machine is not available. The example configuration handler 404 of FIG. 4 initializes the example deployment handler 210 when the configuration settings are validated.

In the illustrated example of FIG. 4, the installation handler 128 is provided with the example commands filterer 406 to filter the commands executed by the deployment handler 210. For example, the commands filterer 406 of FIG. 4 may ensure a secure interface so that the installation handler 128 cannot be misused to gain access to private information on the management client 114 and/or the network 122 of FIG. 1. Thus, in some such examples, the commands filterer 406 provides access to a restricted interface so that, for example, private information is not accessible via a JavaScript engine executed by the web browser 116, potentially harmful commands are not executed, for example, on the management client 114 via instructions executed by the deployment handler 210, etc. In some examples, the commands filterer 406 restricts access to sensitive information (e.g., private information) accessible from, for example, the management client 114. For example, only commands that have been identified by the command filterer 406 as trusted or secure (e.g., a white list of commands) are allowed to execute by the deployment handler 210.

In the illustrated example of FIG. 4, the installation handler 128 is provided with the example workflow handler 414 to enable deployment in a multi-virtual machine environment. For example, the workflow handler 414 may control which virtual machines are deployed, the order of virtual machine deployments, etc. based on, for example, the configuration information obtained by the configuration handler 404.

In the illustrated example of FIG. 4, the installation handler 128 is provided with the example deployment handler 210 to enable importing virtual machine packages to host machines in the virtual computing environment 101. In some examples, the deployment handler 210 enables exporting virtual machine packages from host machines in the virtual computing environment 101. The example deployment handler 210 of FIG. 4 is provided with an example package streamer 408, an example progress monitor 410 and an example package handler 412. The example package streamer 408 of FIG. 4 facilitates streaming the virtual machine package 126 to the target host machine 104 based on the configuration settings verified by the example configuration handler 404 when initializing the deployment handler 210.

In the illustrated example of FIG. 4, the deployment handler 210 is provided with the example progress monitor 410 to monitor deployment progress of the virtual machine package 126 to the host machine 104. For example, the progress monitor 410 may monitor the streaming process of the virtual machine package 126 to the host machine 104 and report the progress to the user interface handler 402 to display via, for example, the web browser 116.

In some examples, the progress monitor 410 monitors the boot process of the virtual machine deployed to the host machine 104. For example, the progress monitor 410 of FIG. 4 employs an IP address assigned to the virtual machine to generate a monitoring link to monitor the boot process. For example, the progress monitor 410 of this example retrieves the IP address of the virtual machine from, for example, the virtual machine tools 218 of the virtualization platform 108. The example progress monitor 410 then constructs the monitoring link (e.g., a uniform resource link) and polls the virtual machine. For example, the progress monitor 410 may periodically, aperiodically, or as a one-time event, poll the web server 306 provided with, for example, the virtual machine template 214 (FIGS. 2 and/or 3). In some such examples, the progress monitor 410 may obtain a JSON document including a progress count on the initialization process in response to the poll. The example progress monitor 410 of FIG. 4 reports the progress to the user interface handler 402 to display via, for example, the web browser 116.

In the illustrated example of FIG. 4, the deployment handler 210 is provided with the example package handler 412 to handle the virtual machine package 126 at the host machine 104 once the virtual machine package 126 is streamed to the host machine 104. For example, the package handler 412 of FIG. 4 may initiate the packaged virtual machine 111. For example, the package handler 412 may activate the PowerOn command on the virtualization platform 108 and, thereby, cause the packaged virtual machine 111 to boot as a virtual machine 110 in the environment 101. In some examples, the package handler 412 may retrieve the customization options selected by the user from the configuration handler 404 to configure the virtual machine 110. For example, the package handler 412 may cause the virtual machine 110 to automatically accept all end user license agreements, set the network association, set the login credentials (e.g., hostname and password) for the host machine 104, set the default SSH setting (e.g., enabled or disabled), etc. In some examples, if the user selected to use third-party installation options such as to use a third-party component (e.g., a third-party database), use a third-party installer program to install a component, etc., the package handler 412 prompts the user for additional information. For example, the package handler 412 may prompt the user to identify the location of the third-party database or to install the component using the third-party installer program at a certain time, etc. In some such examples, the package handler 412 may wait until confirmation is received from the user that the additional information is provided prior to resuming setting the customization options. In some examples, the package handler 412 initiates the package streamer 408 by providing a location for the virtual machine package 126 and the locator for the target host machine 104 (e.g., an IP address of the target host machine).

While an example manner of implementing the example installation handler 128 of FIGS. 1 and/or 2 is illustrated in FIG. 4, one or more of the elements, processes and/or devices illustrated in FIG. 4 may be combined, divided, re-arranged, omitted, eliminated and/or implemented in any other way. Further, any or all of the example network of storage arrays 102, the example host machine 104, the example virtualization platform 108, the example virtual machines 110, the example packaged virtual machine 111, the example virtualization manager 112, the example management client 114, the example web browser 116, the example package hosting server 118, the example repository 120, the example package portal 124, the example virtual machine package 126, the example installation handler installer 206, the example deployment handler 210, the example script executor 212, the example virtual machine tools 218, the example boot handler 302, the example first boot script 304, and the example web server 306 may be implemented by hardware, software, firmware and/or any combination of hardware, software, and/or firmware. In addition, any or all of the example deployment handler 210, the example user interface handler 402, the example configuration handler 404, the example command filterer 406, the example package streamer 408, the example progress monitor 410, the example package handler 412, the example workflow handler 414 and/or, more generally, the example installation handler 128 of FIGS. 1, 2 and 4 may be implemented by hardware, software, firmware and/or any combination of hardware, software and/or firmware. Thus, for example, any of the example network of storage arrays 102, the example host machine 104, the example virtualization platform 108, the example virtual machines 110, the example packaged virtual machine 111, the example virtualization manager 112, the example management client 114, the example web browser 116, the example package hosting server 118, the example repository 120, the example package portal 124, the example virtual machine package 126, the example installation handler installer 206, the example deployment handler 210, the example script executor 212, the example virtual machine tools 218, the example boot handler 302, the example first boot script 304, the example web server 306, the example user interface handler 402, the example configuration handler 404, the example command filterer 406, the example package streamer 408, the example progress monitor 410, the example package handler 412, the example workflow handler 414 and/or, the example installation handler 128 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network of storage arrays 102, the example host machine 104, the example virtualization platform 108, the example virtual machines 110, the example packaged virtual machine 111, the example virtualization manager 112, the example management client 114, the example web browser 116, the example package hosting server 118, the example repository 120, the example package portal 124, the example virtual machine package 126, the example installation handler installer 206, the example deployment handler 210, the example script executor 212, the example virtual machine tools 218, the example boot handler 302, the example first boot script 304, the example web server 306, the example user interface handler 402, the example configuration handler 404, the example command filterer 406, the example package streamer 408, the example progress monitor 410, the example package handler 412 and/or the example workflow handler 414 is/are hereby expressly defined to include a tangible computer readable storage device or storage disk such as a memory, a digital versatile disk (DVD), a compact disk (CD), a Blu-ray disk, etc. storing the software and/or firmware. Further still, the example installation handler 128 of FIGS. 1, 2 and 4 may include one or more elements, processes and/or devices in addition to, or instead of, those illustrated in FIG. 4, and/or may include more than one of any or all of the illustrated elements, processes and devices.

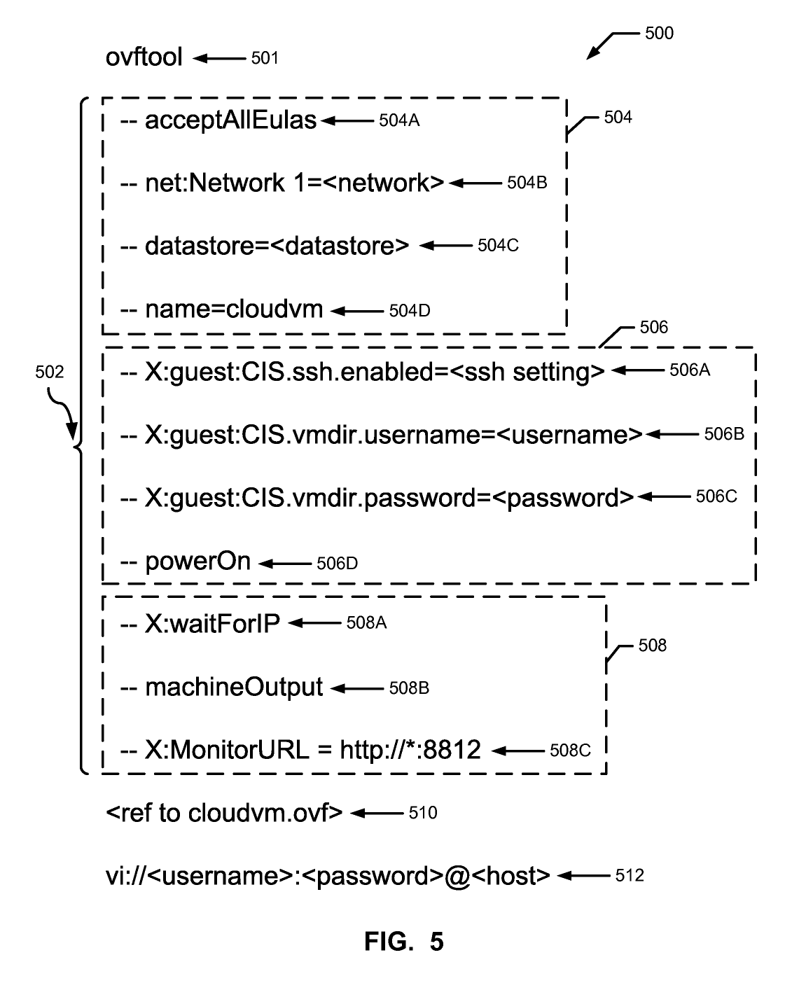

FIG. 5 illustrates an example OVF Tool service command 500 that may be executed to deploy a virtual machine package to a target host machine, and to obtain the necessary feedback from the target host machine to drive a user interface. For example, the OVF Tool service command 500 may be executed by the installation handler 128 of FIGS. 1, 2 and 4. In the illustrated example of FIG. 5, the OVF Tool service command 500 includes an OVF command at line 501, an example options section 502, an example source field 510 and an example target field 512. As described above, the example source field 510 is a reference (e.g., address and/or locator) to the virtual machine package 126, and the example target field 512 is a reference (e.g., address and/or locator) for the host machine 104 on which the virtual machine package 126 is to deploy. In the illustrated example, the options section 502 sets the values of configuration options for deploying the virtual machine package 126. For example, the options section 502 includes an example deployment options block 504, an example initiation options block 506 and an example monitoring options block 508. The example deployment options block 504 of FIG. 5 defines options for the virtual machine package 126. For example, line 504A causes the virtual machine package 126 to accept all end-user license agreements without prompting a user for a response. Lines 504B, 504C and 504D set the network assignment for the deployed virtual machine package 126, specify the datastore name for the source file and the name of the source file, respectively.

In the illustrated example of FIG. 5, the example options section 502 of the OVF Tool service command 500 includes the example initiation options block 506 to power on the packaged virtual machine 111 provided with the virtual machine package 126 and to access the host machine 104. For example, line 506A defines whether SSH is enabled by default for the virtual machine 110, and line 506D powers on (e.g., causes to boot) the packaged virtual machine 111 to thereby implement the virtual machine 110 in the virtual computing environment 101. Example lines 506B and 506C set the login credentials for the host machine 104 (e.g., the username and password, respectively).

In the illustrated example of FIG. 5, the example options section 502 includes the example monitoring options block 508 to enable monitoring the progress of the deployment and initiation processes. For example, lines 508A and 508B define a monitoring link to monitor the progress based on the IP address of the virtual machine 110. Line 508C causes the installation handler 128 to output messages provided by the deployment handler 210.

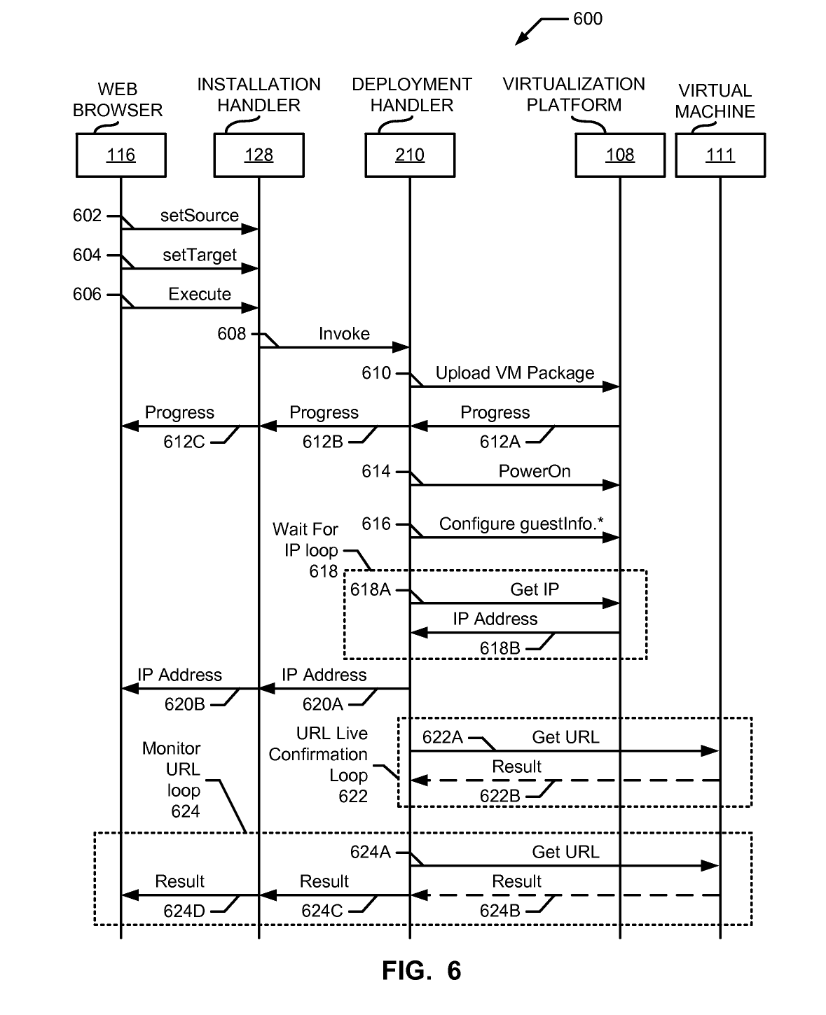

FIG. 6 is an example sequence diagram 600 to facilitate web-based installation of a virtual machine when a user initiates installing the virtual machine. The example sequence diagram 600 includes events executed at the management client 114 and the host machine 104 of FIGS. 1 and 2. For example, the web browser 116, the installation handler 128 and the deployment handler 210 of FIGS. 1 and/or 2 are executed at the management client 114, while the virtualization platform 108 and the packaged virtual machine 111 of FIGS. 1 and 2 are executed at the host machine 104. In the illustrated example of FIG. 6, when the user initiates installing a virtual machine, the web browser 116 sets a source (line 602) and a target (line 604) on a browser plug-in. For example, in response to the user selecting an Install button on the web browser 116, a JavaScript function may execute and cause the web browser 116 to load a source locator (e.g., a reference to the packaged virtual machine package 111) and to load a target locator (e.g., a reference to the target host machine 104) onto the installation handler 128. In some examples, the web browser 116 obtains the source locator and/or the target locator from the example package portal 124 of FIGS. 1 and 2. Once the source locator and target locator are stored in the installation handler 128, the web browser 116 instructs the installation handler 128 to execute (line 606).

In the illustrated example of FIG. 6, the installation handler 128 initializes the deployment handler 210 using the source locator and the target locator (line 608). In some examples, the installation handler 128 is provided with additional, user-provided option settings in initializing the deployment handler 210. For example, the installation handler 128 may be provided with a setting to accept all end user license agreements automatically (e.g., without prompting a user). In some examples, the installation handler 128 validates the source locator, the target locator and the option settings prior to initializing the deployment handler 210. For example, the installation handler 128 may authenticate the source file referenced by the source locator, determine whether the target host machine referenced by the target locator is available, check whether the options are accepted commands (e.g., included in a white list), check whether the options are complete commands, etc. In the illustrated example of FIG. 6, the deployment handler 210 uses the information provided by the installation handler 128 and begins uploading the source file to the target machine (line 610). For example, the deployment handler 210 may initiate streaming the virtual machine package 128 referenced by the source locator to the virtualization platform 108 of the target host machine 104.

In some examples, the upload (e.g., streaming) progress is made available to the user to monitor. In the illustrated example of FIG. 6, the virtualization platform 108 reports a progress count to the deployment handler 210 (line 612A), the deployment handler 210 reports the progress count to the installation handler 128 (line 612B), and the installation handler 128 reports the progress count to the web browser 116 (line 612C). When the upload is complete, the deployment handler 210 initiates the virtualization platform 108 (line 614). For example, the deployment handler 210 may activate the PowerOn command to cause the virtualization platform 108 to boot (or reboot). The example deployment handler 210 uses the environment of the virtual machine package and sets the specified customization options on the virtualization platform 108 (line 616). For example, the deployment handler 210 may auto-generate an ISO image that is injected into a virtual CD-ROM drive, initiate the guestinfo.* mechanism, etc. In the illustrated example, the guestinfo.* mechanism includes one or more extensible machine language (XML) command(s) that enable the deployment handler 210 to list and/or customize the settings of the virtualization platform 108 and/or the packaged virtual machine 111. For example, the guestinfo.* mechanism may be used to set whether SSH is enabled by default on the virtualization platform 108, identify the IP address of the virtualization platform 108 when running, etc. In the illustrated example, a wait for IP loop 618 represents a duration during which the deployment handler 210 waits for the virtualization platform 108 to finish booting and to return the IP address assigned to the virtualization platform 108. For example, the deployment handler 210 of the illustrated example polls the virtualization platform 108 using a GetIP command (line 618A) and then waits until an IP address is returned (line 618B). The example deployment handler 210 returns the IP address to the installation handler 128 (line 620A), and the installation handler 128 returns the IP address to the web browser 116 (line 620B). In some examples, the web browser 116 outputs the IP address for the user to view.

In the illustrated example of FIG. 6, during a URL live confirmation loop 622, the deployment handler 210 uses the IP address of the virtualization platform 108 to monitor an initiation process of the packaged virtual machine 111. For example, the deployment handler 210 of the illustrated example constructs a link to monitor the initiation process using the IP address, and polls the packaged virtual machine 111 (line 622A) for a result (line 622B) indicative of whether the monitoring link is live. For example, the deployment handler 210 of the illustrated example determines whether the result (line 622B) of the poll (line 622A) indicates that a web server provided with the packaged virtual machine 111 is online. When the deployment handler 210 determines that the monitoring link is live, the deployment handler 210 monitors (monitor URL loop 624) the initiation process, and the progress is presented via the web browser 116 for the user to monitor. For example, the deployment tool 210 of the illustrated example polls the packaged virtual machine 111 (line 624A) and receives a result (line 624B) from the packaged virtual machine 111. In the illustrated example, the deployment handler 210 provides the result to the installation handler 128 (line 624C), and the installation handler 128 provides the result to the web browser 116 (line 624D) to display.

The single-virtual machine deployment process may be scaled-out to a multi-virtual machine (e.g., an enterprise software suite) deployment. In some such examples, the package portal 124 and the installation handler 128 deploy one or more virtual machine template(s) to the host machine 104. Deploying an enterprise software suite as a collection of virtual machine templates, where each virtual machine template provides a subset of the services provided with the enterprise software suite, increases performance, availability and extensibility. For example, an enterprise software suite may include certain virtual machines and services to provide management services for the enterprise software suite (e.g., core services) such as a virtual machine to manage automated provisioning of the resources, a virtual machine to enable configuring the host machine, a virtual machine to organize and manage components of the enterprise software suite (e.g., virtual machines and resources), a virtual machine to manage license subscriptions, etc. In some such examples, the virtual machines and services that comprise the core services may be developed, tested and deployed as a whole (e.g., the virtual machine template (VMT2) from Table 1 above).

In addition to deploying virtual machine templates as a whole, when a component of the virtual machine template is updated, the virtual machine template is replaced in its entirety with a new version. As a result, a high degree of robustness is ensured as the set of different permutations for the components of the virtual machine template is kept small. An example scenario involves releasing a virtual machine template including three components in January, releasing a first update and a second update for a first of the three components in March and July, respectively, and releasing an update for a second of the three components in June. In some such examples, if an update for the third of the three components is released in August, rather than complicating the installation process by including a compatibility checker to ensure that the update to the third component is compatible with the January, March and July versions of the first component (e.g., in case a user did not install the first and/or second update), the January and June versions of the second component (e.g., in case the user did not install the first update), and any other components in the enterprise software suite that are coupled to the third component, the virtual machine template and all three components are updated as a whole in March, June, July and August, thereby limiting compatibility concerns to only components coupled to the components of the virtual machine template and not the components of the virtual machine template themselves.

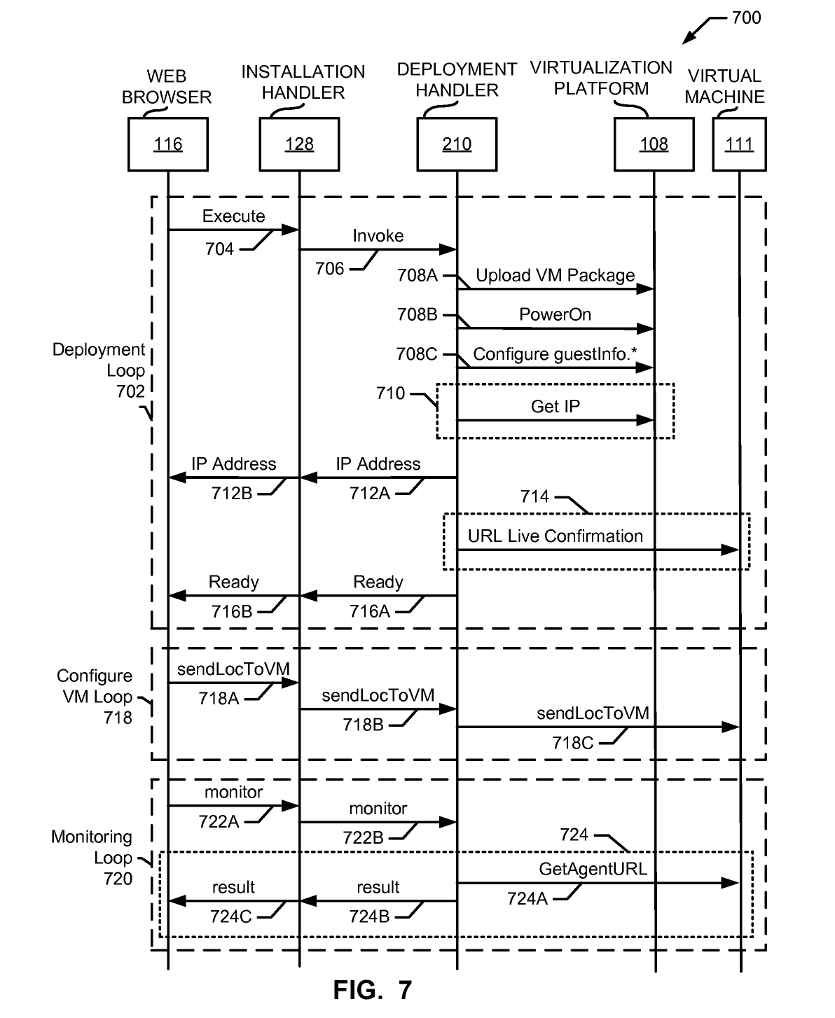

Further, virtual machine templates increase productivity by enabling parallel installation of the components of the enterprise software suite during, for example, an initial installation. FIG. 7 is an example sequence diagram 700 to facilitate web-based installation of an enterprise software suite using virtual machine templates. In the illustrated example of FIG. 7, the virtual machine package(s) used to deploy the enterprise software suite are deployed in parallel. The example sequence diagram 700 is similar to the example sequence diagram 600 of FIG. 6 for a single virtual machine deployment, thereby illustrating the extensibility of scaling-out to a multi-virtual machine deployment. For example, a deployment loop 702 includes the example web browser 116 instructing the example installation handler 128 to execute by initiating the execution command (line 704), and the installation handler 128 initializing the example deployment handler 210 (line 706). In some examples, the workflow handler 414 manages the parallel deployment. When initialized, the deployment handler 210 begins uploading the virtual machine package(s) 126 (FIGS. 1 and 2) to the example virtualization platform 108 (line 708A), initiates the virtualization platform 108 (line 708B), and configures the virtualization platform 108 via customization options (line 708C).

In the illustrated example, the deployment handler 210 waits for the virtualization platform 108 to finish booting and to return the IP address assigned to the virtual machine(s) provided with the virtual machine template(s) and/or virtual machine package(s) to the deployment handler 210 (Get IP loop 710). The example deployment handler 210 returns the IP address (or IP addresses) to the installation handler 128 (line 712A), and the installation handler 128 returns the IP address (or IP addresses) to the web browser 116 (line 712B).

In the illustrated example of FIG. 7, the deployment handler 210 uses the respective IP addresses of the deployed virtual machines 111 to monitor the initiation process of each of the packaged virtual machines 111. For example, during a URL live confirmation loop 714, the deployment handler 210 may poll the packaged virtual machines 111 to determine whether their corresponding monitoring links are live. When a monitoring link for a virtual machine is live, the deployment handler 210 reports the result of the respective polls to the installation handler 128 (line 716A), and the installation handler 128 reports the respective results to the web browser 116 (line 716B).

In some examples, virtual machine templates include script(s) to facilitate the proper initialization of the components of the virtual machine templates. For example, executing the script may cause a component of the virtual machine template to access an enterprise software suite component manager (e.g., an enterprise software suite component manager deployed in virtual machine template (VMT1) of the example Table 1, above) to identify the location(s) of other component(s) in, for example, the virtual machine template, the enterprise software suite, etc. For example, a virtual machine template may be provided with an application server that processes information from a database, and the virtual machine template may include a script to cause the application server to retrieve the location (e.g., IP address) of the database from an enterprise software suite component manager before the application server is fully initialized. In some such examples, the component manager stores the location of components in the enterprise software suite and, thereby, enables virtual machines to discover other components and to connect to each other. In the illustrated example of FIG. 7, the location of the component manager is sent to each of the virtual machines in parallel (configure VM loop 718). For example, the web browser 116 of the illustrated example uses the IP address retrieved from the virtualization platform 108 (line 712B) to generate a locator for the component manager (e.g., a component manager URL) and sends (lines 718A, 718B and 718C) the location of the component manager to each of the packaged virtual machines 111 in order to continue their respective initialization processes.

In the illustrated example of FIG. 7, once a packaged virtual machine 111 receives the location of the component manager, monitoring of the respective initiation processes resumes and the progress is presented via the web browser 116 for the user to monitor (monitoring loop 720). For example, the web browser 116 provides a monitoring link for each of the packaged virtual machines 111 to the deployment handler 210 (lines 722A and 722B). The example web browser 116 of FIGS. 1 and 2 then displays real-time progress for the respective virtual machine initializations (loop 724). For example, the deployment handler 210 of the illustrated example polls the different packaged virtual machines 111 (line 724A) and provides (lines 724B and 724C) results from the packaged virtual machines 111 to the web browser 116 to display to the user.

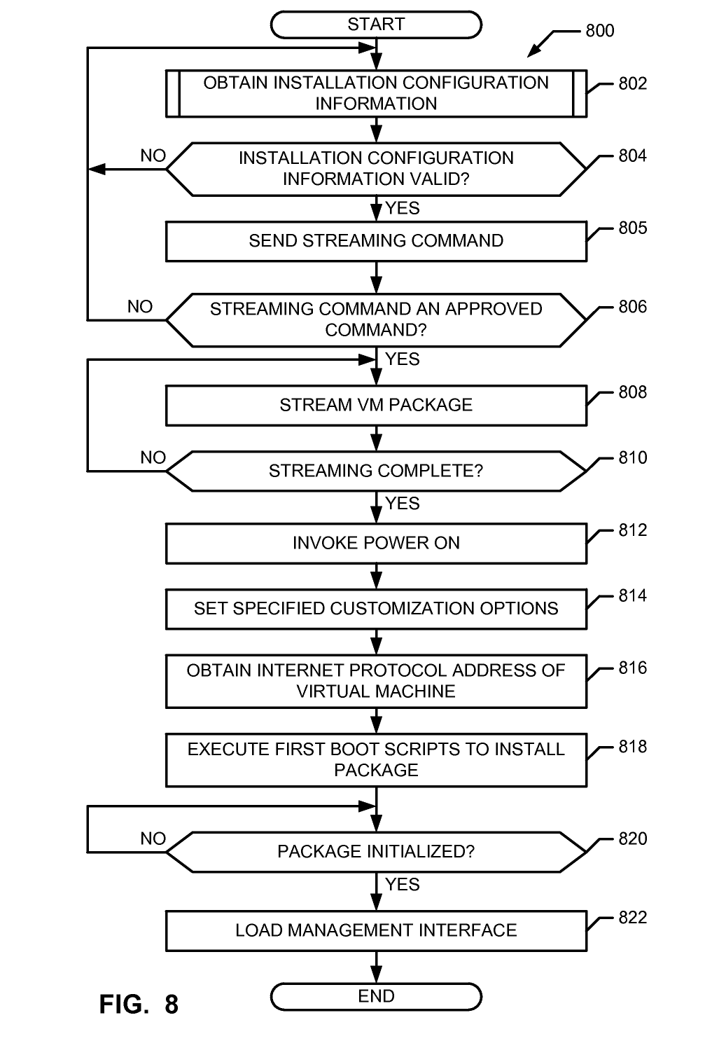

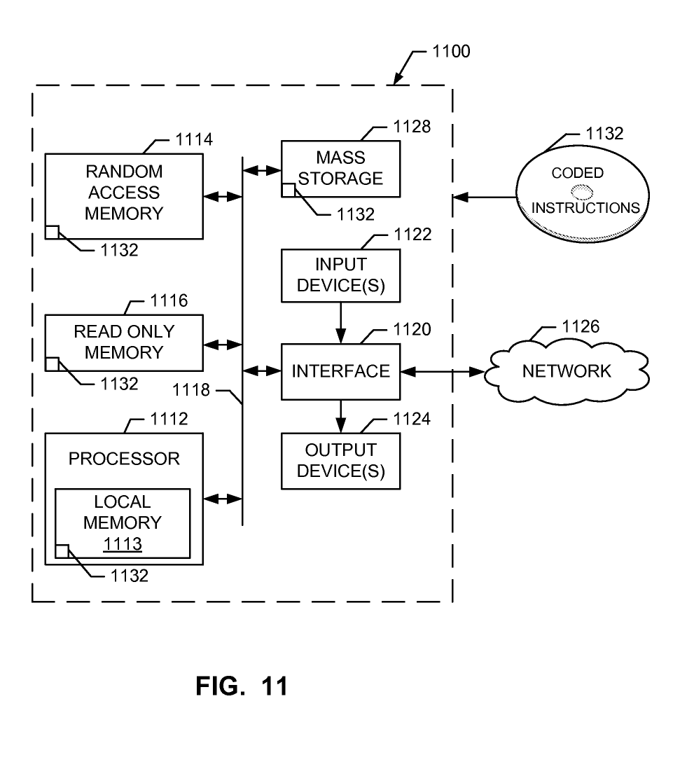

Flowcharts representative of example machine readable instructions for implementing the installation handler 128 of FIGS. 1, 2 and/or 4 are shown in FIGS. 8-10. In this example, the machine readable instructions comprise one or more programs for execution by a processor such as the processor 1112 shown in the example processor platform 1100 discussed below in connection with FIG. 11. The program(s) may be embodied in software stored on a tangible computer readable storage medium such as a CD-ROM, a floppy disk, a hard drive, a digital versatile disk (DVD), a Blu-ray disk, or a memory associated with the processor 1112, but the entire program(s) and/or parts thereof could alternatively be executed by a device other than the processor 1112 and/or embodied in firmware or dedicated hardware. Further, although the example program(s) is/are described with reference to the flowcharts illustrated in FIGS. 8-10, many other methods of implementing the example installation handler 128 may alternatively be used. For example, the order of execution of the blocks may be changed, and/or some of the blocks described may be changed, eliminated, or combined.

As mentioned above, the example processes of FIGS. 8-10 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 8-10 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

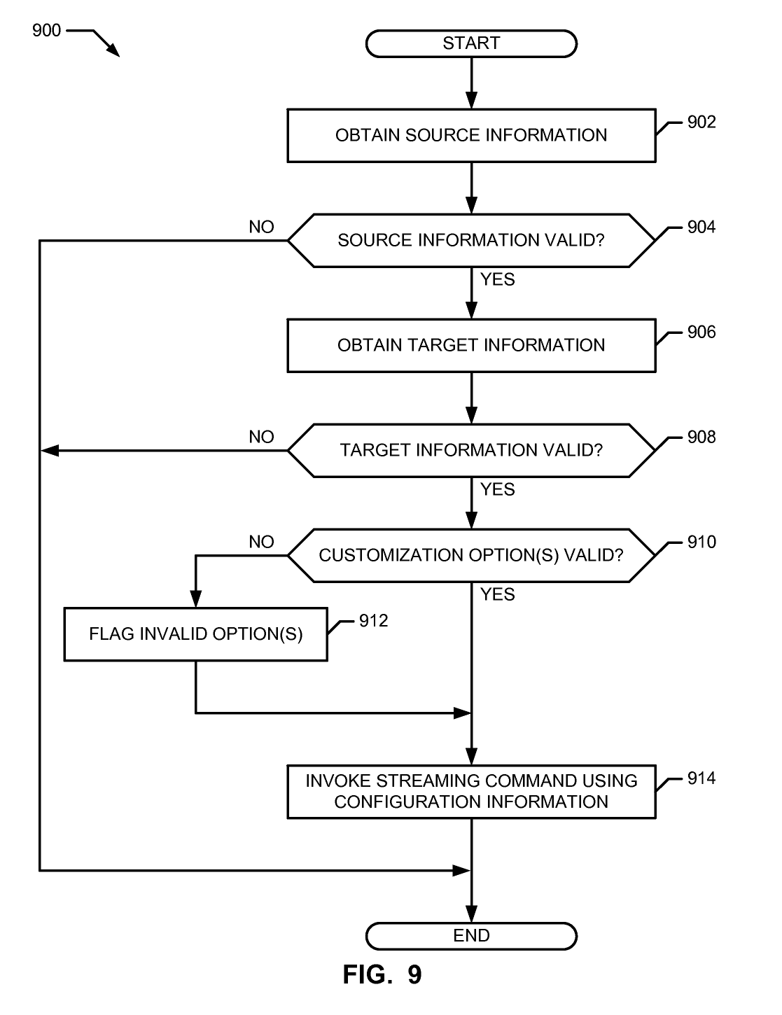

The program of FIG. 8 begins at block 802 when the example installation handler 128 (FIGS. 1, 2 and/or 4) obtains installation configuration information for installing the example virtual machine package 126 (FIGS. 1 and/or 2) onto the example host machine 104 (FIGS. 1 and/or 2). For example, the installation configuration information obtained by the configuration handler 404 (FIG. 4) may include a reference to the source location of the virtual machine package 126, a reference to the target location of the target host machine 104 to deploy to, and customization options for the example packaged virtual machine(s) 111 (FIGS. 1 and/or 2) provided with the virtual machine package 126. In the illustrated example, the configuration handler 404 receives the installation configuration information from the example web browser 116 (FIGS. 1 and/or 2). In the illustrated example, the operation of block 802 may be implemented using the process of FIG. 9 as described. At block 804, the example installation handler 128 determines whether the installation configuration information is valid. For example, the configuration handler 404 may determine that the installation configuration information is invalid if, for example, the virtual machine package 126 is not found at the source location, the target host machine 104 is not found using the reference to the target host machine, etc. If, at block 804, the configuration handler 404 determines that the installation configuration information is invalid, then control returns to block 802 to wait to obtain other installation configuration information. Otherwise, if, at block 804, the configuration handler 404 determines that the installation configuration information is valid, then, at block 805, the example configuration handler 404 requests that the deployment handler 210 stream the virtual machine package 126. At block 806, the example command filterer 406 (FIG. 4) determines whether the command (e.g., the request) to stream the virtual machine package 126 is an approved command. For example, the command filterer 406 may monitor communications between the configuration handler 404 and the deployment handler 210 and, when, for example, the configuration handler 404 sends the request to stream to the deployment handler 210, the command filterer 406 may compare the request to approved commands (e.g., included in a white list). In some examples, the command filterer 406 may monitor the communications between the configuration handler 404 and the deployment handler 210 to check whether access to unauthorized information (e.g., private information) is requested, and block commands attempting to access the unauthorized information. If, at block 806, the command filterer 406 determines that the streaming command is an invalid command (e.g., not an approved command), then control returns to block 802 to wait to obtain other installation configuration information. Otherwise, if, at block 806, the command filterer 406 determines that the streaming command is an approved command, then, at block 808, the example deployment handler 210 streams the virtual machine package 126. For example, the package streamer 408 (FIG. 4) may stream the virtual machine package 126 from the source location to the target host machine 104, may stream a copy of the virtual machine package 126 to respective, multiple target host machines 104, or may stream multiple virtual machine packages 126 (e.g., including virtual machine templates) to one or more target host machine(s) 104.

At block 810, the example deployment handler 210 determines whether the streaming is complete. For example, the example progress monitor 410 (FIG. 4) may poll the example virtualization platform 108 (FIGS. 1 and 2) at the target host machine 108 and monitor the response to the poll to determine when the streaming is complete. If, at block 810, the example progress monitor 410 determines that the package streamer 408 is actively streaming the virtual machine package 126 (e.g., streaming is not complete), then control returns to block 808 to continue streaming the virtual machine package 126. Otherwise, if, at block 810, the progress monitor 410 determines that streaming is complete, then at block 812, the deployment handler 210 initiates the virtualization platform 108. For example, the example package handler 412 may activate the PowerOn command to cause the virtualization platform 108 to boot.

At block 814, the deployment handler 210 sets the specified customization options for installing the packaged virtual machine 111. For example, the package handler 412 may set the packaged virtual machine 111 to accept all end user license agreements, enable SSH into the virtual machine 111 by default, etc. In some examples, the specified customization options may be set before the virtualization platform 108 boots. For example, if the virtual machine package is streamed as an ISO file, then the customization options may be set during the streaming process (e.g., block 808 above). In some examples, if the user elected to use third-party components during the installation process (e.g., a third-party database, a third-party installer program, etc.), the example package handler 412 may wait for the user to complete set-up of the third-party components. In some examples, the package handler 412 may instruct the user to use the third-party installer program to install a corresponding component, and resume setting the specified customization options after the user provides the location (e.g., an IP address) of the component.

At block 816, the component handler 210 obtains the IP address for the packaged virtual machine 111. For example, the progress monitor 410 may retrieve the IP address of the packaged virtual machine 111 from, for example, the virtual machine tools 218 (FIG. 2) of the virtualization platform 108. In some examples, the IP address may be provided by the user. At block 818, the component handler 210 causes the virtualization platform 108 to execute first boot scripts to install the packaged virtual machine(s) 111 of the virtual machine package 126. For example, the package handler 412 may initiate the guestinfo.* mechanism to configure the packaged virtual machine 111. At block 820, the progress monitor 410 determines whether the initialization process is complete and the virtual machine package 126 is initialized. For example, the progress monitor 410 may construct a monitoring URL using the IP address of the packaged virtual machine 111 and poll the packaged virtual machine 111 using the monitoring URL. In some examples, the package monitor 410 may cause the example user interface handler 402 (FIG. 4) to display the initialization process progress to the user as results (e.g., JSON documents) of poll(s) to the monitoring URL are received at the package monitor 410 from the example web server 306 (FIG. 3). If, at block 820, the progress monitor 410 determines that the initialization process is not complete, then control returns to block 820 to monitor for and determine when the initialization process is complete. Otherwise, if, at block 820, the example package monitor 410 determines that the initialization process is complete, then, at block 822, the example installation handler 128 launches a management interface for the installed software. For example, the packaged virtual machine(s) 111 provided with the virtual machine package 126 can be further configured through a web interface provided with the packaged virtual machine 111. The example process 800 of FIG. 8 then ends.

The program of FIG. 9 illustrates an example method of obtaining the installation configuration information for installing a virtual machine (or an enterprise software suite) in the example virtual computing environment 101 (FIG. 1). The example program 900 of FIG. 9 may be used to implement block 802 of FIG. 8. The program 900 of FIG. 9 begins at block 902 when the installation handler 128 (FIGS. 1, 2 and/or 4) obtains source information from the package portal 124 (FIGS. 1 and/or 2). For example, the, package portal 124 may provide the target information to the information handler 128 while the installation handler 128 loads installs on to the management client 114 (FIGS. 1 and/or 2). At block 904, the installation handler 128 determines whether the source information is valid. For example, the example configuration handler 404 (FIG. 4) may determine whether the reference to the virtual machine package 126 points to a live source location (whether a web server provided with the packaged virtual machine 111 is online). In some examples, if the deployment is an online deployment, the example configuration handler 404 checks whether the source location is set to the example repository 120 (FIGS. 1 and 2) over, for example, the public network 122 (FIG. 1). If the deployment is an offline deployment, the example configuration handler 404 determines whether the source location is set to the example network of storage arrays 102 (FIGS. 1 and/or 2) over, for example, the datacenter network 106. In some examples, the source information references multiple virtual machine packages 126. For example, installing an enterprise software suite may include deploying multiple virtual machine packages 126 that include one or more virtual machine templates. In some such examples, the configuration handler 404 may check that a reference to its respective virtual machine package 126 points to a live source location. In some examples, the configuration handler 404 checks the authenticity of the virtual machine package 126 located at the source location. If, at block 904, the example configuration handler 404 determines that the source information is invalid, then the example program 900 of FIG. 9 ends.

Otherwise, if, at block 904, the example configuration handler 404 determines that the source information is valid, then, at block 906, the example information handler 128 obtains target information from the package portal 124. At block 908, the example configuration handler 404 determines whether the target information is valid. For example, the example configuration handler 404 may determine whether the target information includes a reference to the target host machine that points to a live target location. For example, the configuration handler 404 may send a request message to an IP address corresponding to the target host machine to determine if the target host machine is available. In some examples, the target information may reference multiple target host machines. For example, a user may wish to deploy an update (e.g., a patch) for all instances of a packaged virtual machine 111 executing on the host machines 104 (FIGS. 1 and 2) in the example virtual computing environment 101. In some such examples, the configuration handler 404 may determine whether the references to the respective target host machines 104 point to live target locations. If, at block 908, the example configuration handler 404 determines that the target information is invalid, then, the example program 900 of FIG. 9 ends.

Otherwise, if, at block 908, the example configuration handler 404 determines that the target information is valid, then, at block 910, the example configuration handler 404 determines whether the customization option(s) provided by the user are valid. For example, the configuration handler 404 may determine whether an option value is of the correct type for the option (e.g., a true/false value for a binary option). In some examples, the configuration handler 404 determines whether the option specifies an incorrect source file or an incorrect target host machine. If, at block 910, the example configuration handler 404 determines that a customization option is invalid, then, at block 912, the configuration handler 404 flags the invalid customization option. In some examples, flagged customization options are ignored and a default value for that option is used. In some examples, the configuration handler 404 prompts the user to correct flagged customization options.

Otherwise, if, at block 910, the example configuration handler 404 determines that the customization option(s) are valid, or after the configuration handler 404 flags the invalid customization option(s) at block 912, then, at block 914, the example configuration handler 404 executes a streaming command using the configuration information 914. For example, the configuration handler 404 may execute the ovftool command 500 (FIG. 5) and set the valid source information for the source field 510, the valid target information for the target field 512 and the valid customization option(s) for the options field 502. The example program 900 of FIG. 9 then ends.

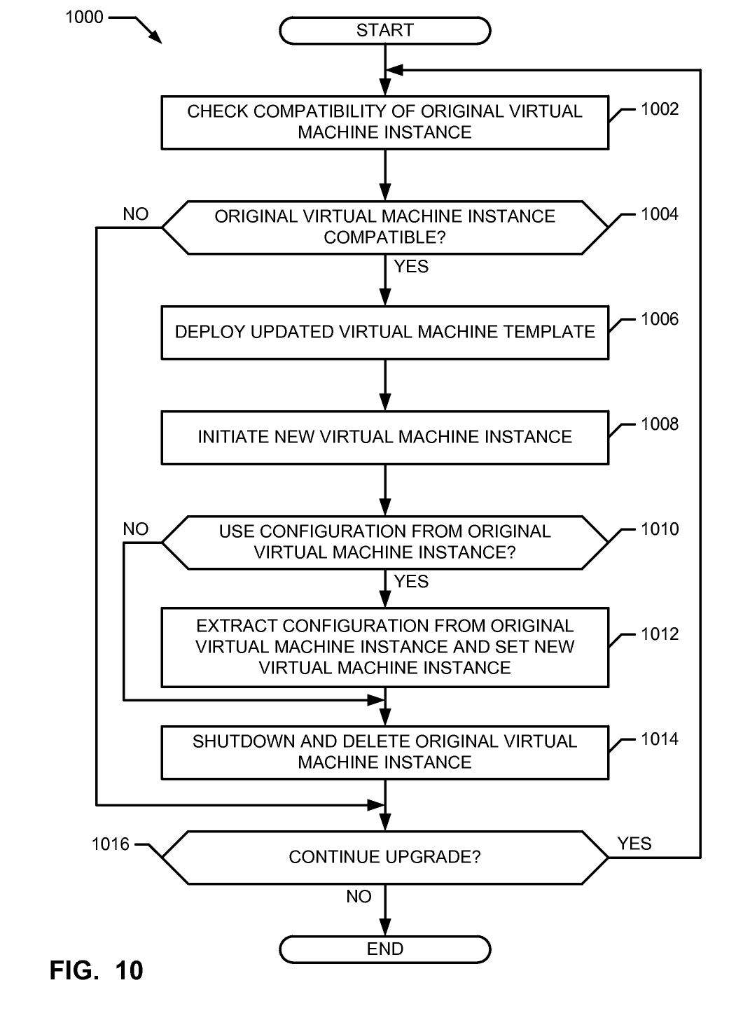

The program of FIG. 10 illustrates an example method of patching an installed enterprise software suite on a machine 104 in the example virtual computing environment 101 (FIG. 1). As described above, it is beneficial to replace a virtual machine template in its entirety when updating a component (e.g., virtual machine) of the virtual machine template. As a result, a patched enterprise software suite appears similar to a fresh (e.g., original) install of the enterprise software suite. The program 1000 of FIG. 10 begins at block 1002 when the example installation handler 128 (FIGS. 1, 2 and 4) checks the compatibility of an original virtual machine instance (e.g., the example virtual machine 110) to an updated virtual machine template (e.g., the virtual machine template 214 (FIGS. 2 and 3)). For example, the configuration handler 404 (FIG. 4) may determine that the example virtual machine 110 does not include software necessary to execute the example packaged virtual machine 111, and that the necessary software is not included in the updated virtual machine template 214. If, at block 1004, the example configuration handler 404 determines that the original virtual machine instance 110 is not compatible with the updated virtual machine template 214, then control proceeds to block 1016 to determine whether to continue the upgrade process.

Otherwise, if, at block 1004, the example configuration handler 404 determines that the original virtual machine instance 110 is compatible with the updated virtual machine template 214, then, at block 1006, the example installation handler 128 deploys the updated virtual machine template 214. For example, the example deployment handler 210 (FIG. 2) may stream the updated virtual machine template 214, including the packaged virtual machine 111, to the target host machine 104 and monitor the streaming process progress. At block 1008, the example installation handler 128 initiates the new virtual machine instance (e.g., the packaged virtual machine 111). For example, the example deployment handler 210 may activate the PowerOn command to boot the virtualization platform 108 (FIGS. 1 and 2) and assign the component(s) of the updated virtual machine template (e.g., the packaged virtual machine 111) IP addresses.

At block 1010, the example installation handler 128 determines whether to use installation configuration information from the original virtual machine instance 110. For example, the example deployment handler 210 may determine whether to configure the example packaged virtual machine 111 with state information extracted from the example virtual machine 110. If, at block 1010, the example installation handler 128 determines to use installation configuration information from the original virtual machine instance, then, at block 1012, the example information handler 128 extracts installation configuration information from the virtual machine 110 and sets the new instance (e.g., the packaged virtual machine 111) with the extracted installation configuration information. For example, the deployment handler 210 may link the packaged virtual machine 111 with the same components as the virtual machine 110. Otherwise, if, at block 1010, the example installation handler 128 determines not to use installation configuration information from the original virtual machine instance 110, or after the information handler 128 extracts configuration information from the original virtual machine instance 110 and sets the packaged virtual machine 111 with the extracted installation configuration information at block 1012, then, at block 1014, the installation handler 128 shuts down and deletes the original virtual machine instance 110. For example, the deployment handler 210 terminates the links to and from the virtual machine 110 and deletes the virtual machine 110.

After the example installation handler 128 shuts down and deletes the original virtual machine instance 110 at block 1014, or if, at block 1004, the configuration handler 404 determines that the original virtual machine instance 110 is not compatible with the updated virtual machine template 214, then, at block 1016, the installation handler 128 determines whether to continue performing upgrades to original virtual machine instances 110. For example, the installation handler 128 may receive a new virtual machine template. If, at block 1016, the example installation handler 128 determines to continue the upgrade process (e.g., the example configuration handler 404 is continuing to receive updated virtual machine template(s) to install in the enterprise software suite), control returns to block 1002 to check compatibility of the original virtual machine instance 110 to the updated virtual machine template(s). Otherwise, if, at block 1016, the installation handler 128 determines to end the upgrade process (e.g., due to a shutdown event, not receiving updated virtual machine templates (e.g., patches), etc.), the example process 1000 of FIG. 10 then ends.

FIG. 11 is a block diagram of an example processor platform 1100 capable of executing the instructions of FIGS. 8-10 to implement the example installation handler 128 of FIGS. 1, 2 and 4. The processor platform 1100 can be, for example, a server or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 may be used to implement the machine readable instructions of FIGS. 8-10 may be stored in the mass storage device 1128, in the volatile memory 1114, in the non-volatile memory 1116, and/or on a removable tangible computer readable storage medium such as a CD or DVD.

From the foregoing, it will be appreciated that the above disclosed methods, apparatus and articles of manufacture perform web-based installation and upgrade architectures for an enterprise software suite, while using limited user feedback, and, thereby, enable simplified installation and upgrade experiences of the enterprise software suite. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method to perform web-based installation of enterprise software, the method comprising:
obtaining configuration information at an installation handler via a web-based interface, the configuration information including a source locator identifying a source location of a source package and a target locator identifying a target machine on which to install the source package, the target machine being separate from the installation handler and the source location;
validating the configuration information; and
in response to determining that the configuration information is valid, deploying the source package to the target machine.

2. A method as defined in claim 1, wherein the validating of the configuration information comprises determining whether the target machine is available to receive the source package.

3. A method as defined in claim 2, wherein determining whether the target machine is available to receive the source package comprises:
sending a message to the target locator; and
determining that the target machine is available based on a response to the message from the target machine.

4. A method as defined in claim 1, wherein deploying the source package to the target machine comprises:
locating the source package identified by the source locator;
determining that the target machine is active based on the target locator; and
causing the source package to be deployed from the source location to the target machine via the installation handler.

5. A method as defined in claim 4, wherein causing the source package to be deployed is performed without storing the complete source package at the installation handler.

6. A method as defined in claim 1, further comprising:
determining that deploying the source package is complete; and
initiating the source package at the target machine via the installation handler.

7. A method as defined in claim 1, wherein the target locator is an internet protocol address of the target machine.

8. A method as defined in claim 1, wherein the source package is a virtual machine installation package including a template.

9. A method as defined in claim 8, wherein the template includes a subset of components of the enterprise software.

10. A method as defined in claim 8, wherein the template further comprises:
a boot handler executing a first boot script, the first boot script facilitating installing the virtual machine installation package at the target machine; and
a web server monitoring initializing a virtual machine included in the template.

11. A system to perform web-based installation of enterprise software, the system comprising:
a portal to generate a source locator identifying a source package to install on a target machine, the portal to generate a target locator identifying the target machine on which to install the source package;
an installation handler to validate configuration information from the portal, the configuration information including the source locator and the target locator; and
a deployment handler to deploy the source package to the target machine in response to the configuration information being valid, the deployment handler being separate from the target machine.

12. A system as defined in claim 11, wherein the portal is further to:
load the installation handler on a client machine; and
initiate the deployment handler when the installation handler determines that the configuration information is valid.

13. A system as defined in claim 11, wherein the installation handler is to provide an interface to facilitate interoperability between the portal and the deployment handler via a JavaScript application program interface, and the portal is to initiate the deployment handler via a JavaScript application program interface command.

14. A system as defined in claim 11 wherein the deployment handler is a command-line based service.

15. A system as defined in claim 11, wherein the installation handler is to validate the configuration information by determining whether the target machine is available to receive the source package.

16. A system as defined in claim 11, further comprising:
a configuration handler to:
send a message to the target locator;
receive a response to the message from the target machine; and
determine that the target machine is available based on the response.

17. A system as defined in claim 11, wherein the deployment handler is to facilitate deploy the source package from the source location to the target machine without storing the complete source package at the deployment handler.

18. A system as defined in claim 17, wherein the deployment handler is to deploy the source package to the target machine without storing the complete source package at the deployment handler.

19. A system as defined in claim 11, further comprising:
a progress monitor to determine when deploying the source package to the target machine is complete, the deployment handler to initiate the source package at the target machine in response to the progress monitor determining that deploying the source package is complete.

20. A system as defined in claim 11, wherein the target locator is an internet protocol address of the target machine.

21. A system as defined in claim 11, wherein the source package is a virtual machine installation package including a template.

22. A system as defined in claim 21, wherein the template includes a subset of components of the enterprise software.

23. A system as defined in claim 11, wherein the template further comprises:
a boot handler to execute a first boot script to facilitate installation of the virtual machine installation package at the target machine; and
a web server to monitor initialization of a virtual machine included in the template.

24. A tangible computer readable storage medium comprising instructions that, when executed, cause a processor to at least:
obtain configuration information at an installation handler via a web-based interface, the configuration information including a source locator identifying a source location of a source package and a target locator identifying a target machine on which to install the source package, the target machine is separate from the installation handler and the source location;
validate the configuration information; and
in response to determining that the configuration information is valid, deploy the source package to the target machine.

25. A tangible computer readable storage medium as defined in claim 24, wherein the instructions further cause the processor to validate the configuration information by determining whether the target machine is available to receive the source package.

26. A tangible computer readable storage medium as defined in claim 25, wherein the instructions further cause the processor to determine whether the target machine is available by:
sending a message to the target locator;
receiving a response to the message from the target machine; and
determining that the target machine is available based on the response.

27. A tangible computer readable storage medium as defined in claim 24, wherein the instructions further cause the processor to deploy the source package to the target machine by:
locating the source package identified by the source locator;
determining that the target machine is active based on the target locator; and
causing the source package to be deployed from the source location to the target machine via the installation handler.

28. A tangible computer readable storage medium as defined in claim 27, wherein the instructions further cause the processor to deploy the source package to the target machine without storing the complete source package at the installation handler.

29. A tangible computer readable storage medium as defined in claim 24, wherein the instructions further cause the processor to:
determine that deploying the source package is complete; and
initiate the source package at the target machine via the installation handler.

30. A tangible computer readable storage medium as defined in claim 24, wherein the target locator is an internet protocol address of the target machine.

31. A tangible computer readable storage medium as defined in claim 24, wherein the source package is a virtual machine installation package including a template.

32. A tangible computer readable storage medium as defined in claim 31, wherein the template includes a subset of components of an enterprise software suite.

33. A tangible computer readable storage medium as defined in claim 31, wherein the template further comprises:
a boot handler to execute a first boot script to facilitate installation of the virtual machine installation package at the target machine; and
a web server to monitor initialization of a virtual machine included in the template.
